(19) United States
(12) Patent Application Publication
(10) Pub. No.: US 2008/0102907 A1
(43) Pub. Date: May 1, 2008

(54) Hinge mechanism combined with electric wire, portable end device, and cellular phone

(75) Inventor: Yasushi Komine, Hino-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/789,596

(22) Filed: Apr. 25, 2007

(30) Foreign Application Priority Data
Oct. 31, 2006 (JP) 2006-296635

(51) Int. Cl. H04M 1/00; E05D 7/00

(52) U.S. Cl. 455/575.3; 16/239

(57) ABSTRACT

A hinge mechanism includes a rotation center shaft and a shaft rotationally supporting member, supported by first and second members respectively. One of the shaft and the supporting member includes a configuration to make an intermediate portion of a flexible electric wire extending between the first and second members being in contact with the shaft and to prevent the intermediate portion from being away from the shaft with a rotation of the shaft with respect to the supporting member. A portable end device includes first and second electric units contained in the hinged first and second members and electrically connected to each other by the electric wire. In a cellular phone, an operation unit to operate at least one of the electric units and a speaker are provided on one of inner surfaces of the housings, and a display unit and a receiver are provided on the other.

### CROSS-REFERENCE TO RELATED APPLICATIONS

This application is based upon and claims the benefit of priority from prior Japanese Patent Application No. 2006-296635, filed Oct. 31, 2006, the entire contents of which are incorporated herein by reference.

### BACKGROUND OF THE INVENTION

1. Field of the Invention

Embodiments of the present invention relate to a hinge mechanism combined with an electric wire, and a pivotally foldable and openable, so-called a clam-shell type, portable end device and cellular phone.

2. Description of the Related Art

The above described portable end device is known as a cellular phone or a portable information device.

The portable end device of this kind is provided with a first housing in which a first printed wiring board is housed and an operation unit is arranged, a second housing in which a second printed wiring board is housed and a display unit is arranged, and a hinge mechanism which rotationally connects one end portion of the first housing and one end portion of the second housing. The first printed wiring board and the second printed wiring board are electrically connected by a flexible electric wire extending between the first housing and the second housing through the hinge mechanism.

Jpn. Pat. Appln. KOKAI Publication No. 2005-101316 illustrates an example of such a conventional flexible electric wire. The conventional electric wire is a flexible wiring board in which electric lines are formed on a flexible board and which is bent and stretched with the rotational movement of one of the first housing and second housing with respect to the other around the hinge mechanism. The flexible wiring board is easier to break as the bending radius is smaller.

To prevent the breakage of the flexible wiring board by repeating rotation of one of the first and second housings with respect to the other around the hinge mechanism, the flexible wiring board is loosely wound around a rotation shaft of the hinge mechanism with a predetermined play. As a result, a radius around the rotation shaft of the hinge mechanism becomes large.

### BRIEF SUMMARY OF THE INVENTION

According to one aspect of the invention, a hinge mechanism, rotationally connecting a first member and a second member and combined with a flexible electric wire extending between the first member and the second member, comprises: a rotation center shaft supported by the first member; and a shaft supporting member supported by the second member and rotationally supporting the rotation center shaft, and one of the rotation center shaft and the shaft supporting member, including a configuration to make an intermediate portion of the electric wire between the first member and the second member being in contact with the rotation center shaft and to prevent the intermediate portion of the electric wire from being away from the rotation center shaft with a rotation of the rotation center shaft with respect to the shaft supporting member.

According to one aspect of the invention, a portable end device comprises: a first housing containing a first electric unit and having one end portion; a second housing containing a second electric unit and having one end portion; a hinge mechanism including a rotation center shaft supported by one of the one end portion of the first housing and that of the second housing and a shaft supporting member supported by the other of the one end portion of the first housing and that of the second housing and supporting the rotation center shaft rotationally, the hinge mechanism connecting the one end portion of the first housing and that of the second housing each other to make one of the first housing and the second housing being rotational with respect to the other between an open position and a folded position; and an electric wire electrically insulated and extending between the first housing and the second housing while contacting the rotation center shaft of the hinge mechanism, the electric wire having a flexibility and electrically connecting the first electric unit and the second electric unit.

According to one aspect of the invention, a cellular phone comprises: a first housing containing a first electric unit and having one end portion; a second housing containing a second electric unit and having one end portion; a hinge mechanism including a rotation center shaft supported by one of the one end portion of the first housing and that of the second housing and a shaft supporting member supported by the other of the one end portion of the first housing and that of the second housing and supporting the rotation center shaft rotationally, the hinge mechanism connecting the one end portion of the first housing and that of the second housing each other to make one of the first housing and the second housing being rotational with respect to the other between an open position and a folded position; and an electric wire electrically insulated and extending between the first housing and the second housing while contacting the rotation center shaft of the hinge mechanism, the electric wire having a flexibility and electrically connecting the first electric unit and the second electric unit, at least one of the first electric unit and the second electric unit including a circuit for transmitting and receiving electric waves for a cellular phone, each of the first housing and the second housing having an inner surface facing each other at the folded position, an operation unit configured to operate at least one of the first electric unit and the second electric unit and a speaker being provided on one of the inner surfaces of the first and second housings, and a display unit and a receiver being provided on the other of the inner surfaces of the first and second housings.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view schematically showing an internal structure in an outer surface side of a first housing while a cellular phone that is a kind of a portable end device according to an embodiment of the invention is folded around hinge mechanisms;

FIG. 2 is a perspective view schematically showing an internal structure in an outer surface side of a second housing of the cellular phone of FIG. 1;

FIG. 3 is a perspective view schematically showing internal structures in inner surface sides of the first and second housings while the cellular phone of FIG. 1 is opened around the hinge mechanisms;

FIG. 4 is a perspective view schematically showing internal structures in outer surface sides of the first and second housings while the cellular phone of FIG. 1 is opened;

FIG. 5 is an enlarged perspective view schematically showing the hinge mechanisms of the cellular phone of FIG. 1 while being folded, and a part of the internal structure located near to the hinge mechanisms in the outer surface side of the first housing;

FIG. 6 is an enlarged perspective view schematically showing the hinge mechanisms of the cellular phone of FIG. 2 while being folded, and a part of the internal structure located near to the hinge mechanisms in the outer surface side of the second housing;

FIG. 7 is an enlarged perspective view schematically showing combinations of the hinge mechanisms and electric wires provided in the hinge mechanisms, while the first and second housings are being folded around the hinge mechanisms as shown in FIG. 1;

FIG. 8 is an enlarged perspective view schematically showing the combinations of the hinge mechanisms and the electric wires provided in the hinge mechanisms, while the first and second housings are being opened around the hinge mechanisms as shown in FIG. 3; and

FIG. 9 is an enlarged perspective view schematically showing a combination of a hinge mechanism and an electric wire provided in the hinge mechanism, the combination according to another embodiment of the invention and being used in a cellular phone that is a kind of a portable end device.

### DETAILED DESCRIPTION OF THE INVENTION

### One Embodiment

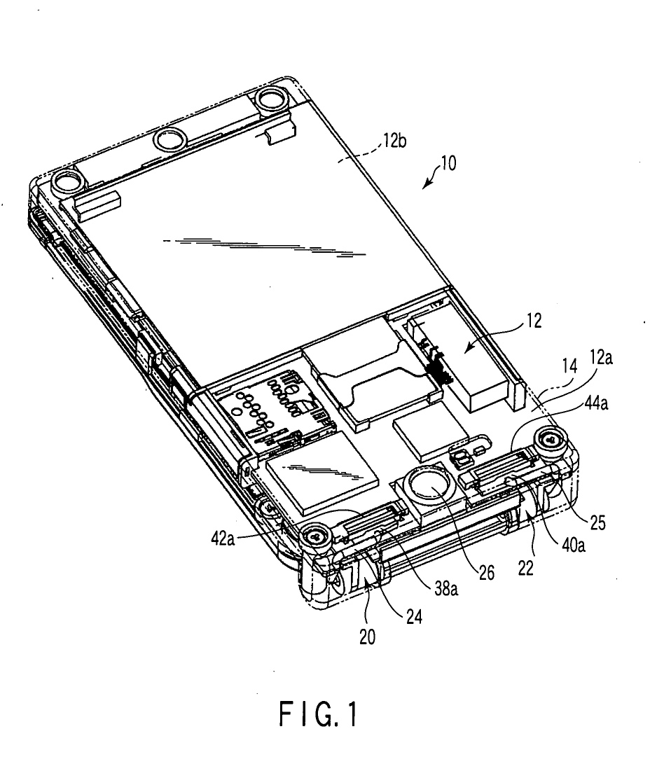

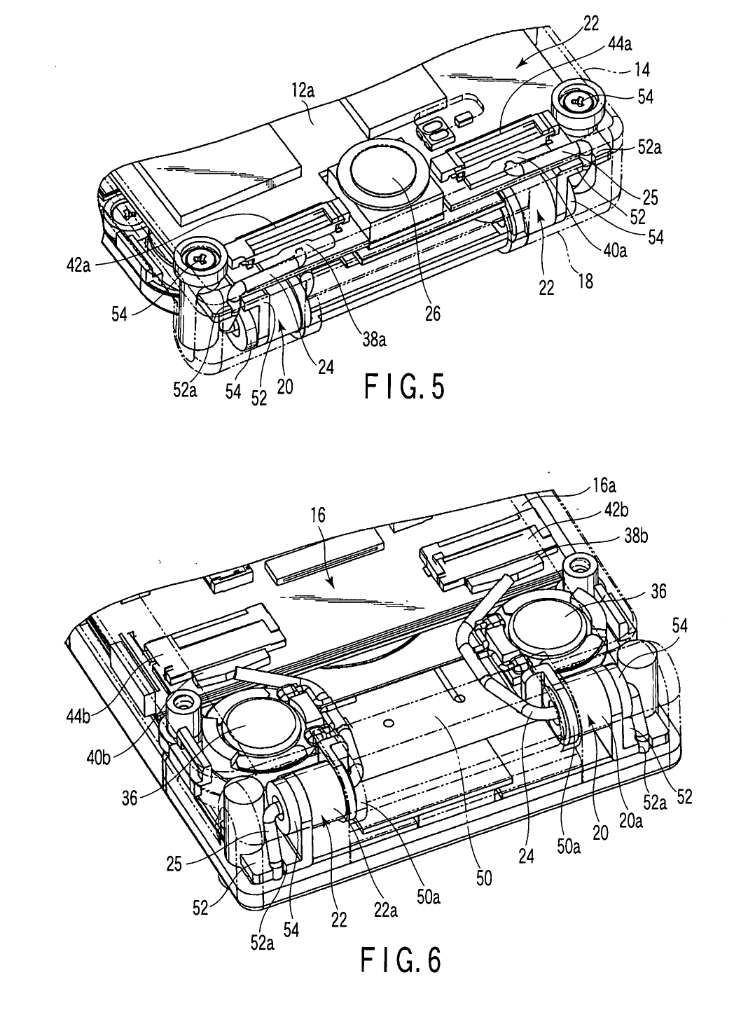

Whole configuration of a portable end device 10 according to an embodiment of the invention will be described with reference to FIG. 1 to FIG. 8. The portable end device 10 is a so-called cellular phone.

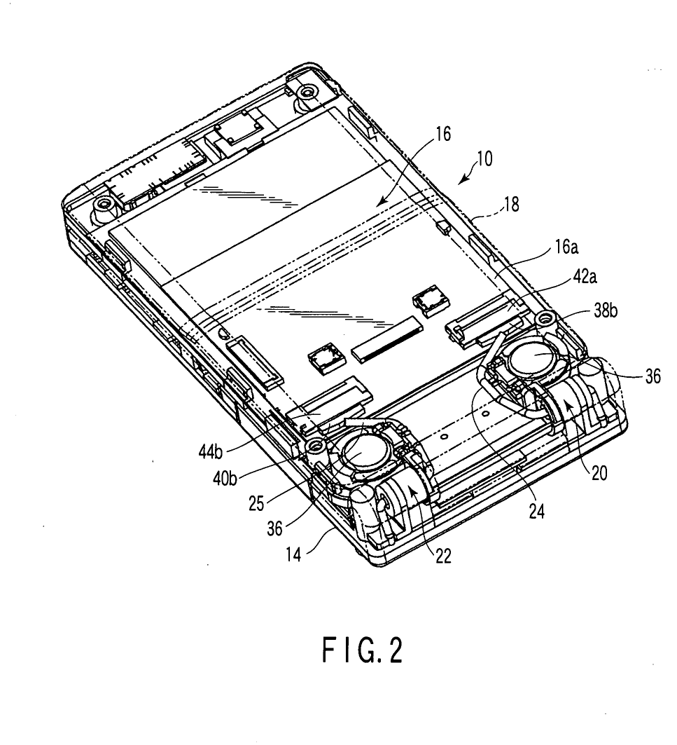

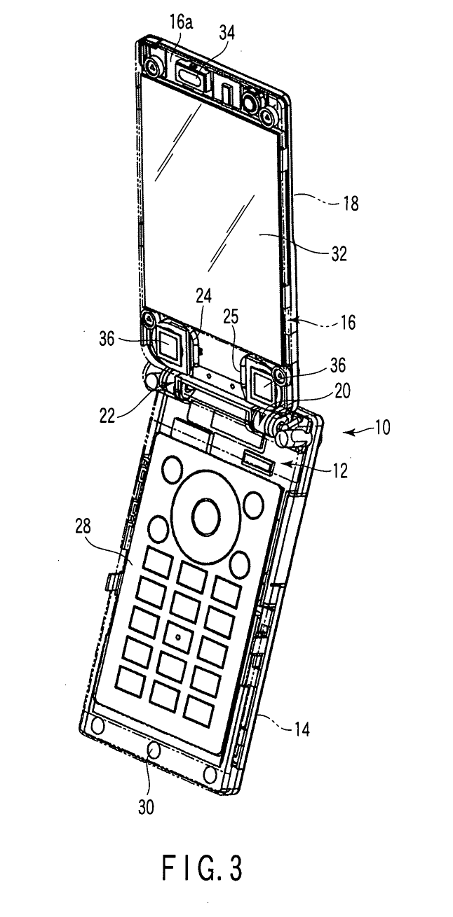

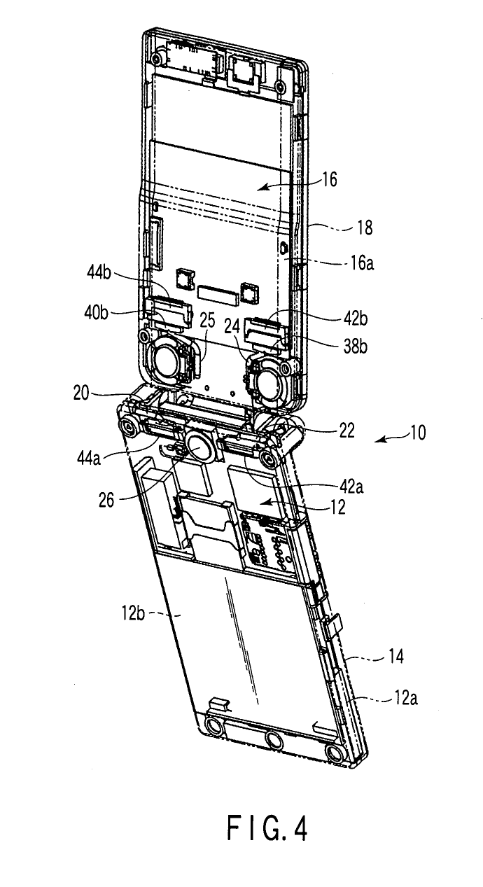

The portable end device 10 comprises a first housing 14 containing a first electrical unit 12, a second housing 18 containing a second electrical unit 16, and at least one hinge mechanism, two hinge mechanisms 20 and 22 in this embodiment, connecting one end portion of the first housing 14 and one end portion of the second housing 18 to make one of the first housing 14 and the second housing 18 being rotational with respect to the other of the first housing 14 and the second housing 18 between an open position (shown in FIG. 3 and FIG. 4) and a folded position (shown in FIG. 1 and FIG. 2). The first electrical unit 12 and the second electrical unit 16 are electrically connected by electric wires 24 and 25 extending between the first housing 14 and second housing 18 through the hinge mechanisms 20 and 22.

Two hinge mechanisms 20 and 22 are arranged between the one end portion of the first housing 14 and the one end portion of the second housing 18 so that these hinge mechanisms 20 and 22 are coaxially with each other and separated from each other in a direction along a rotation center line of each of the hinge mechanisms 20 and 22.

The first electrical unit 12 includes a first printed wiring board 12a provided with various electric or electronic circuits for performing various functions as a cellular phone (the circuits including all or at least one part of a circuit for transmitting and receiving electric waves for the cellular phone), and a battery pack 12b being detachably and electrically connected to the first printed wiring board 12a.

Each of the first and second housings 14 and 18 has an outer surface which is always exposed to an outer space at either folded position (shown in FIG. 1 and FIG. 2) or open position (shown in FIG. 3 and FIG. 4). The battery pack 12b is detachably loaded at a predetermined position in an inner space of the first housing 14 and is covered by a battery cover (not shown for clarifying the drawing) removably provided on the outer surface of the first housing 14.

In the one end portion of the outer surface of the first housing 14, an image pickup camera 26 is arranged between the two hinge mechanisms 20 and 22. The camera 26 is electrically connected to the various electronic or electric circuits on the printed wiring board 12a.

The first and second housings 14 and 18 have inner surfaces which are faced each other and hidden from the outer space at the folded position (shown in FIG. 1 and FIG. 2) and exposed to the outer space at the open position (shown in FIG. 3 and FIG. 4).

In a central portion of the inner surface of the first housing 14, an operation unit 28 including various function keys is provided. The function keys of the operation unit 28 are electrically connected to the electronic or electric circuits on the first printed wiring board 12a. At the other end portion opposite to the one end portion of the first housing 14 in the inner surface, a speaker microphone 30 is provided. The speaker microphone 30 is electrically connected to the electronic or electric circuits on the first printed wiring board 12a.

In a central portion of the inner surface of the second housing 18, a thin display unit 32 is provided. In this embodiment, the thin display unit 32 is a liquid crystal display unit. At the other end portion opposite to the one end portion of the second housing 18 in the inner surface, a receiver 34 for the cellular phone is provided. Stereo speakers 36 are arranged at two positions separated to each other and adjacently corresponding to the two hinge mechanisms 20 and 22 in the inner surface of the one end portion of the second housing 18.

The second electrical unit 16 includes a second printed wiring board 16a provided with various electric or electronic circuits for driving the thin display unit 32, the receiver 34, and the stereo speakers 36. The thin display unit 32, the receiver 34, and the stereo speaker 36 are electrically connected to the electric or electronic circuits on the second printed wiring board 16a.

A not-shown antenna device is housed in the second housing 18. The various electric or electronic circuits on the second printed wiring board 16a of the second electric unit 16 include an electronic or electric circuit for the not-shown antenna device. The not-shown antenna device is electrically connected to the various electric or electronic circuits on the second printed wiring board 18a. In a case that the first electric unit 12 includes one part of the circuit for transmitting and receiving electric waves for the cellular phone, the circuits on the second printed wiring board 18a of the second electric unit 16 include the other part of the circuit for transmitting and receiving electric waves for the cellular phone.

The electric wires 24 and 25 electrically connecting the first electric unit 12 of the first housing 14 and the second electric unit 16 of the second housing 18 with each other are electric cables in this embodiment. One end portions of the electric wires 24 and 25 at the first electric unit 12 have insertion-type connectors 38a and 40a, and the other end portions of the electric wires 24 and 25 at the second electric unit 12 have insertion-type connectors 38b and 40b.

At least one position adjacent to at least one hinge mechanism, two positions adjacent to the two hinge mechanisms 20 and 22 in this embodiment, on the first printed wiring board 12a of the first electric unit 12 in one end portion of the first housing 14 are provided with two receiving-type connectors 42a and 44a into which the insertion-type connectors 38a and 40a are detachably inserted. The receiving-type connectors 42a and 44a are electrically connected to the electronic or electric circuits on the first printed wiring board 12a through not-shown electric wirings on the first printed wiring board 12a. At least one position adjacent to at least one hinge mechanism, two positions corresponding to the two hinge mechanisms 20 and 22 with the two stereo speakers 36 interposed therebetween in this embodiment, on the second printed wiring board 16a of the second electric unit 16 in one end portion of the second housing 18 are provided with two receiving-type connectors 42b and 44b into which the insertion-type connectors 38b and 40b are detachably inserted. The receiving-type connectors 42b and 44b are electrically connected to the electronic or electric circuits on the second printed wiring board 16a through not-shown electric wirings on the second printed wiring board 16a.

Next, combinations of the hinge mechanisms 20 and 22 and the electric wires 24 and 25 extending through them will be described in more detail with reference to FIG. 5 to FIG. 8.

The hinge mechanisms 20 and 22 include rotation center shafts 20a and 22a supported by one of the one end portion of the first housing 14 and the one end portion of the second housing 18, and shaft supporting members 20b and 22b supported by the other of the one end portion of the first housing 14 and the one end portion of the second housing 18 and rotationally supporting the rotation center shafts 20a and 22a.

In this embodiment, each of the rotation center shafts 20a and 22a has a cylindrical shape having the same outer dimensions as to each other. The rotation center shafts 20a and 22a are arranged coaxially at two positions separated from each other by a predetermined distance in the direction along each of the rotation center lines thereof. A connection member 50 extends along each of the rotation center lines of the rotation center shafts 20a and 22a between the rotation center shafts 20a and 22a in an outside of outer circumferential surfaces of the rotation center shafts 20a and 22a in a radial direction of each of them. Shaft fixing portions 50a are bent at both ends of the connection member 50 toward the rotation center lines of the rotation center shafts 20a and 22a and integrally connected to end surfaces of the rotation center shafts 20a and 22a facing each other.

An end portion of the outer circumferential surface of each of the rotation center shafts 20a and 22a opposite to each other is formed as a step with a smaller diameter than a diameter of the other portion of the outer circumferential surface of each of the rotation center shafts 20a and 22a. Each of the shaft supporting members 20b and 22b includes a bearing portion rotationally supporting the small-diameter step of each of the rotation center shafts 20a and 22a, and a base portion 52 bent toward the small-diameter step of each of the rotation center shafts 20a and 22a at an end of the bearing portion in the outside of the outer circumferential surface of each of the rotation center shafts 20a and 22a in the radial direction thereof.

A circular shaped stopper 54 is fixed to the small-diameter step of each of the rotation center shafts 20a and 22a in an outside of the bearing portion of each shaft supporting member 20b or 22b. The circular shaped stopper 54 ensures a free rotation of the small-diameter step of each of the rotation center shafts 20a and 22 with respect to each of the bearing portions of the shaft supporting members 20b and 22b, and prevents a drop of the bearing portion of each of the shaft supporting members 20b and 22b from the small-diameter step of each of the rotation center shafts 20a and 22a.

The electric wires 24 and 25 are inserted into center holes 20c and 22c of the rotation center shafts 20a and 22a of the hinge mechanisms 20 and 22.

The one end portions of the electric wires 24 and 25, having the insertion-type connectors 38a and 40a to be inserted into the receiving-type connectors 42a and 44a on the first printed wiring board 12a of the first electric unit 12 in the first housing 14, extend from the outside ends of the center holes 20c and 22c of the rotation center shafts 20a and 22a of the hinge mechanisms 20 and 22 along the bearing portions toward sides of the bearing portions opposing to the base portions 52, that is, a space between the hinge mechanisms 20 and 22, through engagement elements 52a of the base portions 52.

The other end portions of the electric wires 24 and 25, having the insertion-type connectors 38b and 40b to be inserted into the receiving-type connectors 42b and 44b on the second printed wiring board 16a of the second electric unit 16 in the second housing 16, extend from the inside ends of the center holes 20c and 22c of the rotation center shafts 20a and 22a of the hinge mechanisms 20 and 22 along the two shaft fixing portions 50a at the both ends of the connection member 50 so as to be separated farther from the rotation center shafts 20a and 22a in the radial direction of each of the shafts 20a and 22a through engagement elements 50b at the both end portions of the connection member 50.

The base portions 52 of the shaft supporting members 20b and 22b of the hinge mechanisms 20 and 22 are fixed to both ends of an inner bottom surface of the one end portion of the first housing 14 by well known fixing means, fixing screws 54 in this embodiment, after the insertion-type connectors 38a and 40a of the electric wires 24 and 25 for the first electric unit 12 in the first housing 14 are inserted into the receiving-type connectors 42a and 44a on the first printed wiring board 12a of the first electric unit 12 in the first housing 14.

The connection member 50 of the hinge mechanisms 20 and 22 is fixed to a center of an inner bottom surface of the one end portion of the second housing 18 by well known fixing means, not-shown fixing screws in this embodiment, after the insertion-type connectors 38b and 40b of the electric wires 24 and 25 for the second electric unit 16 in the second housing 18 are inserted into the receiving-type connectors 42b and 44b on the second printed wiring board 16a of the second electric unit 16 in the second housing 18.

In the portable end device 10 configured as described in detail hereinbefore, the first electric unit 12 in the first housing 14 and the second electric unit 16 in the second housing 18 are electrically connected through the electric wires 24 and 25. Therefore, compared with a case that the first electric unit 12 and the second electric unit 16 are electrically connected through only one electric wire, outer dimensions of each of the electric wires 24 and 25 become smaller than that of the one electric wire, and also each of the electric wires 24 and 25 becomes more flexible than the one electric wire.

The two electric wires 24 and 25 extend with being in contact with the rotation center shafts 20a and 22a by passing through the center holes 20c and 22c of the rotation center shafts 20a and 22a of the hinge mechanisms 20 and 22. One of the both end portions of each electric wire 24 or 25 is engaged with the engaging element 52a of the base portion 52 of each shaft supporting member 20b or 22b of the hinge mechanisms 20 and 22, and the other of the both end portions of each electric wire 24 or 25 is engaged with each engaging element 50b of the connection member 50 of the hinge mechanisms 20 and 22.

Each electric wire 24 or 25 with the small outer dimensions contributes to reduce the outer dimensions of each rotation center shaft 20a or 22a. Each electric wire 24 or 25 with its both end portions being engaged with each hinge mechanism 20 or 22 contributes to reduce the outer dimensions of the combination of each hinge mechanism 20 or 22 with each electric wire 24 or 25.

Since the hinge mechanisms 20 and 22 are separated from each other in the direction along the rotation center line of each hinge mechanism 20 or 22 on the one end portion of each of the first and second housings 14 and 18, a space not filled by the first electric unit 12 and second electric unit 16 is generated between the hinge mechanisms 20 and 22 in at least one of the one end portions of the first and second housings 14 18 so that the image pickup camera 26 can be arranged in the vacant space. The vacant space can be used to house any other members than the image pickup camera 26.

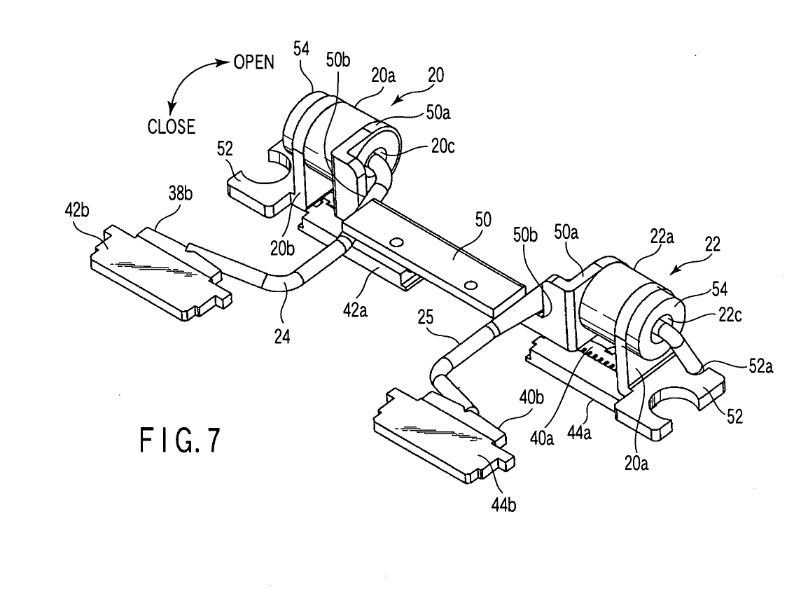

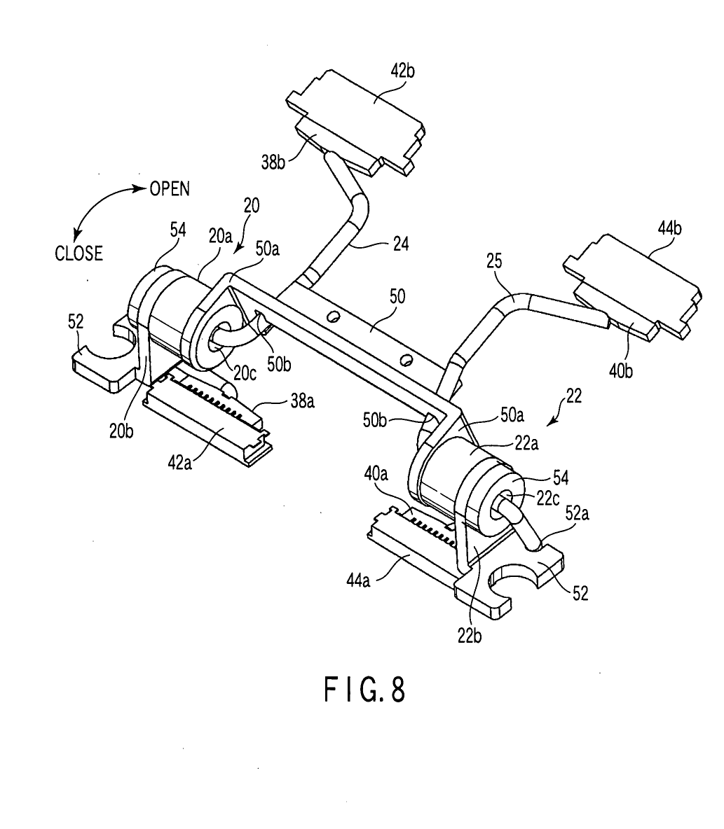

A bi-directional arrow shown around one of the rotation center shafts 20a and 22a of the hinge mechanisms 20 and 22 in each of FIG. 7 and FIG. 8 indicates rotational movement directions of each of the rotation center shafts 20a and 22a with respect to each of the shaft supporting members 20b and 22b in the hinge mechanisms 20 and 22, in which one of the first and second housings 14 and 18 rotates with respect to the other between the folded position shown in each of FIG. 1 and FIG. 2 and the open position shown in each of FIG. 3 and FIG. 4. The direction of the arrow, marked “OPEN”, indicates a rotational movement direction of each of the rotation center shafts 20a and 22a being necessary for the open position. The direction of the arrow, marked “CLOSE”, indicates a rotational movement direction of each of the rotation center shafts 20a and 22a being necessary for the folded position.

The first housing 14 and the second housing 18 are held at each of the folded position shown in each of FIG. 1 and FIG. 2 and the open position shown in each of FIG. 3 and FIG. 4 against a predetermined external force by a not-shown known cam mechanism combined with each hinge mechanism 20 or 22.

### Another Embodiment

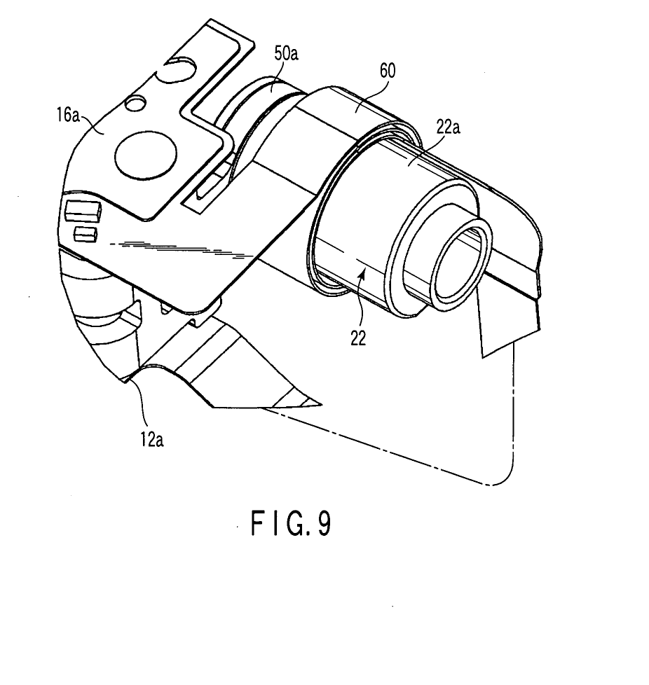

Now, an essential part of a combination of the hinge mechanism 22, used in the cellular phone which is one kind of the portable end device 10 and according to another embodiment of the invention, with an electric wire 60 will be described with reference to FIG. 9.

In this embodiment, an elongated flexible wiring board is used as the electric wire 60, instead of the electric cable used as each electric wire 24 or 25, in the combination with each of the hinge mechanisms 20 and 22 in the cellular phone which is one kind of the portable end device 10 according to the one embodiment of the invention and described hereinbefore with reference to FIG. 1 to FIG. 8. The flexible wiring board of the electric wire 60 is configured by forming electric wires necessary for electrically connecting the first electric unit 12 in the first housing 14 and the second electric unit 16 in the second housing 18 on an elongated flexible board, and the electric wires are insulated.

An intermediate portion of the flexible wiring board of the electric wire 60 is loosely wound on the outer circumferential surface of the rotation center shaft 20a or 22a of the hinge mechanism 20 or 22 corresponding to the flexible wiring board of the electric wire 60, and both end portions of the flexible wiring board of the electric wire 60 are electrically connected to the first electric unit 12 in the first housing 14 and the second electric unit 16 in the second housing 18. This electrical connection can be performed by electrically and directly connecting terminals at both end portions of the flexible wiring board of the electric wire 60 with external connection terminals provided on the first printed wiring board 12a of the first electric unit 12 and external connection terminals provided on the second printed wiring board 16a of the second electric unit 16. Alternatively, the above described electrical connection can be performed by electrically and indirectly by the combination of the insertion-type connectors 38a, 38b, 40a, 40b and the receiving-type connectors 42a, 42b, 44a, 44b which are used for electrically connecting the both end portions of the electric wire 24 of the electric cable and those of the electric wire 25 of the electric cable with the first printed wiring board 12a of the first electric unit 12 and the second printed wiring board 16a of the second electric unit 16 in the one embodiment described hereinbefore.

In this embodiment, while the first housing 14 and the second housing 18 are rotated around the hinge mechanisms 20 and 22 between the folded position shown in each of FIG. 1 and FIG. 2 and the open position shown in each of FIG. 3 and FIG. 4, the winding of the intermediate portion of the flexible wiring board of the electric wire 60 on the outer circumferential surface of the one of the rotation center shafts 20a and 22a of the hinge mechanisms 20 and 22 corresponding thereto becomes loose or tight a little, but don't largely separate, hang down or bend from the outer circumferential surface. Therefore, compared with the conventional case described hereinbefore, the combination of the elongated flexible wiring board of the electric wire 60 with each of the hinge mechanisms 20 and 22 can be achieved in small outer dimensions.

In each of the one embodiment and another embodiment described hereinbefore, the cellular phone is described as an example of the portable end device 10 to which the invention is applied. However, the portable end device 10 can be any one of various portable information devices other than the cellular phone.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A hinge mechanism, rotationally connecting a first member and a second member and combined with a flexible electric wire extending between the first member and the second member, comprising:
a rotation center shaft supported by the first member; and
a shaft supporting member supported by the second member and rotationally supporting the rotation center shaft, and
one of the rotation center shaft and the shaft supporting member, including a configuration to make an intermediate portion of the electric wire between the first member and the second member being in contact with the rotation center shaft and to prevent the intermediate portion of the electric wire from being away from the rotation center shaft with a rotation of the rotation center shaft with respect to the shaft supporting member.

2. The hinge mechanism according to claim 1, wherein
the rotation center shaft includes a shaft fixing portion fixed to the rotation center shaft and fixed to the first member in an outer side of an outer circumferential surface of the rotation center shaft in a radial direction of the rotation center shaft,
the shaft supporting member includes a bearing portion rotationally supporting the rotation center shaft and a base portion fixed to the bearing portion and fixed to the second member in the outer side of the outer circumferential surface of the rotation center shaft in the radial direction of the rotation center shaft, and
each of the shaft fixing portion and the base portion having an engagement element being engaged with the intermediate portion of the electric wire.

3. The hinge mechanism according to claim 1, wherein
the rotation center shaft has a cylindrical shape, and
the intermediate portion of the electric wire is passed through the center hole of the rotation center shaft.

4. The hinge mechanism according to claim 1, wherein the electric wire includes an electric cable.

5. The hinge mechanism according to claim 1, wherein
the electric wire includes an elongated flexible wiring board, and
the elongated flexible wiring board is wound on an outer circumferential surface of the rotation center shaft.

6. A portable end device comprising:
a first housing containing a first electric unit and having one end portion;
a second housing containing a second electric unit and having one end portion;
a hinge mechanism including a rotation center shaft supported by one of the one end portion of the first housing and that of the second housing and a shaft supporting member supported by the other of the one end portion of the first housing and that of the second housing and supporting the rotation center shaft rotationally, the hinge mechanism connecting the one end portion of the first housing and that of the second housing each other to make one of the first housing and the second housing being rotational with respect to the other between an open position and a folded position; and
an electric wire electrically insulated and extending between the first housing and the second housing while contacting the rotation center shaft of the hinge mechanism, the electric wire having a flexibility and electrically connecting the first electric unit and the second electric unit.

7. The portable end device according to claim 6, wherein
the rotation center shaft has a cylindrical shape, and
the electric wire is passed through a center hole of the rotation center shaft of the hinge mechanism between the first housing and the second housing.

8. The portable end device according to claim 6, wherein the electric wire includes an electric cable.

9. The portable end device according to claim 6, wherein
the electric wire includes an elongated flexible wiring board, and
the flexible wiring board is wound on an outer circumferential surface of the rotation center shaft of the hinge mechanism.

10. The portable end device according to claim 6, wherein
connectors are connected to both ends of the electric wire, and
each of the first electric unit and the second electric unit has a connector electrically and removably connected to the connector at each of the both ends of the electric wire.

11. The portable end device according to claim 6, wherein
each of the first housing and the second housing has an inner surface facing each other at the folded position,
an operation unit configured to operate at least one of the first electric unit and the second electric unit is provided on one of the inner surfaces of the first and second housings, and
a display unit is provided on the other of the inner surfaces of the first and second housings.

12. The portable end device according to claim 6, further comprising
at least one hinge mechanism arranged coaxially to the rotation center shaft of the above described hinge mechanism between the one end portion of the first housing and the one end portion of the second housing and separated from the above described hinge mechanism in a direction along the rotation center shaft of the above described hinge mechanism, the at least one hinge mechanism cooperating with the above described hinge mechanism to make the one of the first housing and the second housing being rotational with respect to the other between the open position and the folded position, and
wherein the electric wire extends while contacting at least one of the rotation center shafts of the hinge mechanisms.

13. The portable end device according to claim 12, wherein an image pickup camera is arranged between the hinge mechanisms in one of the one end portion of the first housing and that of the second housing.

14. The portable end device according to claim 12, wherein speakers are arranged in the other of the one end portion of the first housing and that of the second housing to correspond to the hinge mechanisms.

15. The portable end device according to claim 12, wherein
each of the first housing and the second housing has an inner surface facing each other at the folded position,
an operation unit configured to operate at least one of the first electric unit and the second electric unit is provided on one of the inner surfaces of the first and second housings, and
a display unit is provided on the other of the inner surfaces of the first and second housings.

16. A cellular phone comprising:
a first housing containing a first electric unit and having one end portion;
a second housing containing a second electric unit and having one end portion;
a hinge mechanism including a rotation center shaft supported by one of the one end portion of the first housing and that of the second housing and a shaft supporting member supported by the other of the one end portion of the first housing and that of the second housing and supporting the rotation center shaft rotationally, the hinge mechanism connecting the one end portion of the first housing and that of the second housing each other to make one of the first housing and the second housing being rotational with respect to the other between an open position and a folded position; and
an electric wire electrically insulated and extending between the first housing and the second housing while contacting the rotation center shaft of the hinge mechanism, the electric wire having a flexibility and electrically connecting the first electric unit and the second electric unit,
at least one of the first electric unit and the second electric unit including a circuit for transmitting and receiving electric waves for a cellular phone,
each of the first housing and the second housing having an inner surface facing each other at the folded position,
an operation unit configured to operate at least one of the first electric unit and the second electric unit and a speaker being provided on one of the inner surfaces of the first and second housings, and
a display unit and a receiver being provided on the other of the inner surfaces of the first and second housings.

17. The cellular phone according to claim 16, wherein
the rotation center shaft has a cylindrical shape, and
the electric wire includes an electric cable and is passed through a center hole of the rotation center shaft of the hinge mechanism between the first housing and the second housing.

18. The cellular phone according to claim 16, wherein
the electric wire includes an elongated flexible wiring board, and
the flexible wiring board is wound on an outer circumferential surface of the rotation center shaft of the hinge mechanism.

19. The cellular phone according to claim 16, further comprising
at least one hinge mechanism arranged coaxially to the rotation center shaft of the above described hinge mechanism between the one end portion of the first housing and the one end portion of the second housing and separated from the above described hinge mechanism in a direction along the rotation center shaft of the above described hinge mechanism, the at least one hinge mechanism cooperating with the above described hinge mechanism to make the one of the first housing and the second housing being rotational with respect to the other between the open position and the folded position,
wherein the electric wire extends while contacting at least one of the rotation center shafts of the hinge mechanisms, and
an image pickup camera is arranged between the hinge mechanisms in one of the one end portion of the first housing and that of the second housing.

20. The cellular phone according to claim 16, further comprising
at least one hinge mechanism arranged coaxially to the rotation center shaft of the above described hinge mechanism between the one end portion of the first housing and the one end portion of the second housing and separated from the above described hinge mechanism in a direction along the rotation center shaft of the above described hinge mechanism, the at least one hinge mechanism cooperating with the above described hinge mechanism to make the one of the first housing and the second housing being rotational with respect to the other between the open position and the folded position,
wherein the electric wire extends while contacting at least one of the rotation center shafts of the hinge mechanisms, and
speakers are arranged in the other of the one end portion of the first housing and that of the second housing to correspond to the hinge mechanisms.
